(19) United States
(12) Patent Application Publication
(10) Pub. No.: US 2010/0057818 A1
(43) Pub. Date: Mar. 4, 2010

(54) PERFORMING DEFRAGMENT ON HARD DISK OF HOST MACHINE HAVING A VIRTUAL MACHINE

(75) Inventors: Zhi Guo Gao, Beijing (CN); Qi Ming Tian, Beijing (CN); Qing Bo Wang, Beijing (CN); Zhe Xiang, Beijing (CN); Jin Zhou, Beijing (CN)

Correspondence Address: IBM CORPORATION, T.J. WATSON RESEARCH CENTER, P.O. BOX 218, YORKTOWN HEIGHTS, NY, 10598, US

(73) Assignee: INTERNATIONAL BUSINESS MACHINES CORPORATION, Armonk, NY (US)

(21) Appl. No.: 12/548,880

(22) Filed: Aug. 27, 2009

(30) Foreign Application Priority Data
Aug. 28, 2008 (CN) 200810213096.4

(51) Int. Cl. G06F 12/02; G06F 12/00

(52) U.S. Cl. 707/813; 711/112; 711/170; 711/E12.001; 711/E12.002; 707/E17.01

(57) ABSTRACT

A method, system, and article of manufacture tangibly embodying computer readable instructions for performing defragment on a physical hard disk of a host machine system having a virtual machine (VM) system. The host machine system performs contiguous storage of each file on the VM and the host machine with only one defragment. The host machine obtains a physical position distribution of data blocks in the hard disk constituting a VM file in the VM system according to VM file allocation information of the VM system and the host machine system file allocation information.

### CROSS-REFERENCE TO RELATED APPLICATION

This application claims priority under 35 U.S.C§119(a) from Chinese Patent Application no. 200810213096.4, filed on Aug. 28, 2008, the entire contents of which is incorporated herein by reference.

### BACKGROUND OF THE INVENTION

1. Field of the Invention

The present invention relates to a method, system and article of manufacture tangibly embodying a computer readable medium for performing defragment on a hard disk, and more particularly to a method, system and article of manufacture tangibly embodying a computer readable medium for performing defragment on a physical hard disk of a host machine system including a virtual machine.

2. Description of the Related Art

The virtual machine (VM) technology has been widely used in many application fields. FIG. 7 shows exemplary VM systems and a host machine system. As shown in FIG. 7, pluralities of VM systems 201-204 are created in the host machine system. The host machine system further includes a service console, and a VMWare® virtualization layer between the host machine system and the VM systems. The host machine system, for example, has an Intel® architecture and can include a CPU, memory, hard disk and network interface card. The host machine system allocates resources for the VM systems according to different usages and its available resources, respectively, such as the CPU, hard disk, I/O interface, etc. Each VM is enabled to execute different applications independently. In the host machine system, an operating system (OS) and applications in each single VM are considered to be executed in a real independent computer similar to a host machine.

As shown in FIG. 7, an OS such as Windows 2000® from the Microsoft Corporation can be run on the VMs, and the VM systems store and read files on/from virtual hard disks allocated for the VMs and independently perform various operations. The application of the above VMs has various benefits. For example, since a plurality of VM systems can be created in a host machine system, it is only necessary to purchase the host machine to execute various tasks in parallel without interference with each other. When the tasks are completed, the resources occupied by the VMs can be released or flexibly scaled so as to be applied to other tasks. Thus, hardware investment can be greatly reduced and the scalability and flexibility of the system can be significantly improved. Furthermore, the VM systems can further guarantee resource allocation for mission-critical applications. Owing to the above benefits, about 40% reduction in hardware and software costs and about 70% reduction in maintenance costs can be achieved by the use of the VM systems in the practical application.

A virtual disk used in a VM system is generally represented in the form of a huge file in a physical hard disk of a host machine. For example, the VM system can be a VMWare® system from the VMWare Corporation and its virtual disk is stored as, for example, a file of “*.vmdk” in the physical hard disk of the host machine. In the prior art, there are mainly three methods for allocating hard disk space for the VM in the host machine:

1) allocating the hard disk space on the host machine to the VM at the time of creating the VM—for example, allocating a predetermined space, e.g. 40 GB, for the virtual hard disk of the VM at the time of creating the VM;

2) allocating the hard disk space for the VM successively—for example, allocating a predetermined space on the host machine hard disk for the VM as required, e.g. allocating a 2 GB space for the VM when it applies each time; or

3) dynamically allocating the VM the hard disk space it needs on the host machine hard disk, wherein the allocated hard disk space can be continuously increased as the VM needs—the VM, is allocated a space as required on the physical hard disk of the host machine.

It is well known that there is a need for defragging a hard disk to eliminate fragmentation periodically or non-periodically in the existing operating system. Here, the fragmentation occurs because a file, when stored, is stored at plural incontiguous positions in the hard disk due to various reasons. If there are excessive fragments, when accessing a file, a magnetic head of the hard disk has to frequently jump to different physical positions to perform the access. As a result, access time for the file is prolonged and the service life of the hard disk is shortened, thereby deteriorating system performance. Thus, in order to solve the above problem, it is necessary to perform periodic or non-periodic defragment of the hard disk to store each file at contiguous physical positions as far as possible, so that the number of track seeking times of the magnetic head is reduced when these files are read.

The circumstance of defragment performed in a host machine system on which a VM system is running is analyzed below. The host machine's hard disk has a huge file (hereinafter referred to as a huge file A, which corresponds to a virtual hard disk of a VM) for the VM and other various files thereon. When allocating space for the huge file A on the physical hard disk of the host machine during the creation of the VM system: according to the aforementioned allocating method 1), the host machine hard disk cannot have a contiguous free space of the required size, and thus the huge file A can occupy incontiguous storage positions on the hard disk of host machine; according to the aforementioned allocating methods 2) and 3), due to the nature of successive allocation and dynamical allocation per se, it is a good possibility that the huge file A occupies incontiguous storage positions on the host machine hard disk.

As described above, the host machine needs to perform defragment of the huge file A and other files on the host machine. Next, with respect to the VM system, as shown in FIG. 7, since an operating system such as Windows 2000® is also running on the VM, when the VM performs reading and writing of a file on its virtual hard disk, the incontiguous file storage situation also occurs for the virtual hard disk. In order to improve the system performance, it is also necessary to perform periodic or non-periodic defragment of the VM to alleviate this problem.

FIGS. 8a-8c exemplarily show a process of performing hard disk defragment of a host machine system including a VM in the prior art. As shown in FIG. 8a, on the physical hard disk of the host machine, a huge file A corresponding to the VM contains a plurality of fragments, for example, A1 to A3. A VM file C on the virtual hard disk also contains a plurality of fragments, for example, C1 to C4. Since the virtual hard disk corresponds to the huge file A on the host machine hard disk, each of the portions C1 to C4 of the VM file C on the virtual hard disk corresponds to a portion of the huge file A, respectively. FIG. 8a schematically shows such a relation. The host machine hard disk further has other files thereon, such as a file B. The file B contains a plurality of fragments, for example, B1 to B2.

In the prior art, typically the host machine first needs to perform defragment of the files on the physical hard disk of the host machine. As shown in FIG. 8b, after the defragment, the huge file A and other files on the host machine (such as the file B) are moved to contiguous physical positions on the host machine hard disk, respectively. However, the contiguous storage of the huge file A on the host machine hard disk cannot ensure the VM file C on the virtual hard disk to be simultaneously stored at contiguous positions on the virtual hard disk, and as shown in FIG. 8b, after the defragment of the physical hard disk of the host machine, the file C on the virtual hard disk still contains fragments. Thus, it is further necessary to re-defrag the virtual hard disk so as to realize contiguous storage of each file on the virtual hard disk. After the re-defragment, as shown in FIG. 8c, the result that each file is stored at contiguous positions on both the virtual hard disk and the physical hard disk of the host machine has been achieved.

As described above, in order to achieve the result that each file is stored at contiguous positions on both the virtual hard disk and the physical hard disk of the host machine, the existing technical solution needs to perform hard disk defragment twice, so that the defragment time for the system is increased and operation costs are increased, and the service life of the hard disk is degenerated.

In view of the above, there is a need for providing a technique of enabling the files on the host machine hard disk and the virtual hard disk to be stored at contiguous physical positions by performing defragment one time.

### SUMMARY OF THE INVENTION

In one aspect, the present invention provides a method for performing defragment on a physical hard disk of a host machine system having a virtual machine (VM) system. The method includes obtaining a physical position distribution on the physical hard disk of data blocks constituting a VM file in the VM system according to VM file allocation information of the VM system and host machine file allocation information of the host machine system.

According to another aspect of the present invention, a hard disk defragment apparatus is provided for performing defragment on a physical hard disk of a host machine system having a virtual machine (VM) system. The hard disk defragment apparatus includes a physical position distribution acquiring unit for obtaining a physical position distribution on the physical hard disk of data blocks constituting a VM file in the VM system according to VM file allocation information of the VM system and host machine file allocation information of the host machine system.

According to a further aspect, the present invention provides an article of manufacture tangibly embodying a computer readable program containing executable program instructions which when executed, implements the steps of a method according to claim 1.

### BRIEF DESCRIPTION OF THE DRAWINGS

FIG. 1 shows a flowchart of a hard disk defragment method according to an aspect of the present invention;

FIGS. 2a-2b are views showing a process of performing defragment of a hard disk of a VM and a physical hard disk of a host machine according to an aspect of the present invention;

FIG. 3 shows a flowchart of further steps of the hard disk defragment method shown in FIG. 1;

FIG. 4 shows a block diagram of a hard disk defragment apparatus according to aspects of the present invention;

FIG. 5 shows a block diagram of a hard disk defragment apparatus according to another aspect of the present invention;

FIG. 6 shows a flowchart of a hard disk defragment method according to another aspect of the present invention;

FIG. 7 shows a host machine system including a VM system according to the prior art; and

FIGS. 8a-8c show a process of performing defragment of a physical hard disk of the host machine including the VM system according to the prior art.

The present invention will be easily understood by reference to the following description of the preferred embodiments when read in conjunction with the accompanying drawings in which same or corresponding reference numerals refer to same or corresponding characteristics or components.

### DETAILED DESCRIPTION OF THE PREFERRED EMBODIMENTS

In one aspects, the present invention can enable files on the physical hard disk of the host machine and the virtual hard disk to be stored contiguously by performing defragment one time so that fragments are decreased and the defragment method is simplified, thereby improving the system performance.

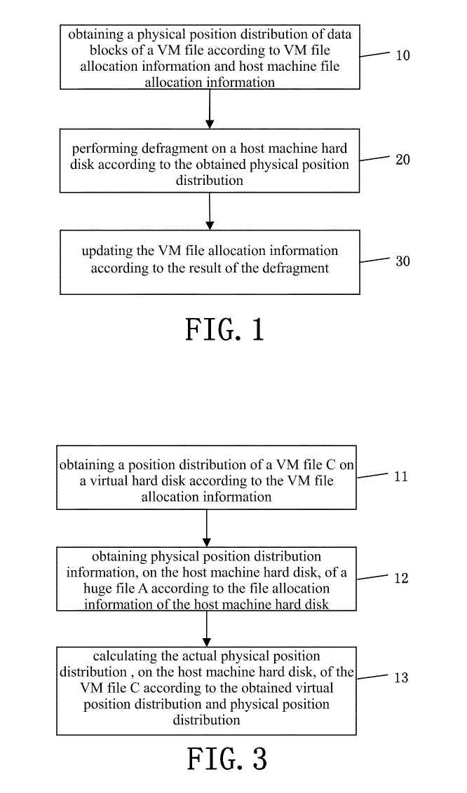

FIG. 1 typically shows a flowchart of a hard disk defragment method according to an embodiment of the present invention. At step 10, a physical position distribution in the physical hard disk of data blocks constituting a VM file in the VM system are obtained according to VM file allocation information of the VM system and host machine file allocation information of the host machine system. At step 20, defragment of the physical hard disk of the host machine is performed according to the obtained physical position distribution.

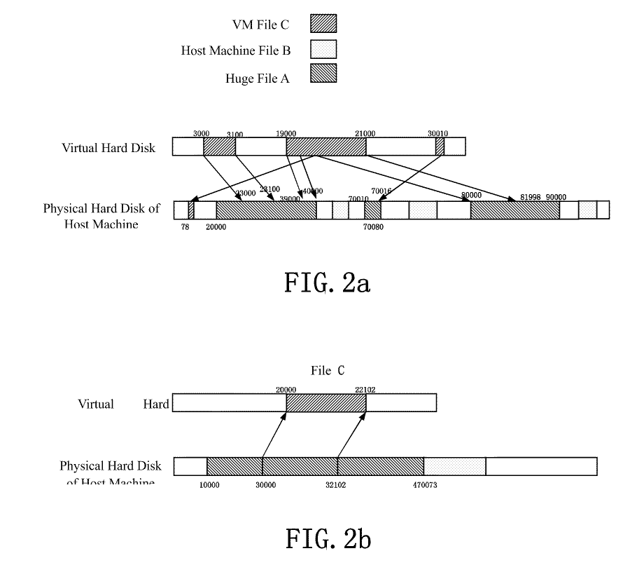

Referring to FIGS. 2a and 2b and FIG. 3, the hard disk defragment method according to an embodiment of the present invention is described in detail below. FIG. 2a shows an example that fragmentation occurs on both a hard disk of a VM and a host machine hard disk, wherein a virtual hard disk of the VM exists on the host machine hard disk in the form of a huge file A, and a plurality of files in the VM system exist on the virtual hard disk of the VM. It should be appreciated that for the sake of simplified illustration, FIGS. 2a and 2b only exemplarily show a VM file (file C) on the virtual hard disk. However, the method of the present invention can be applied to all the files on the virtual hard disk.

As shown in FIG. 3, step 10 further includes steps 11, 12 and 13. At step 11, a position distribution of the VM file C on the virtual hard disk is obtained according to the file allocation information of the VM. As shown in FIG. 2a, for example, the VM file C occupies in turn on the virtual hard disk data blocks 3000-3100, 30010 and 19000-21000 according to the VM file allocation information. At step 12, a physical position distribution of the huge file A on the host machine hard disk is obtained according to file allocation information of the host machine hard disk. For example, in FIG. 2a, the huge file A occupies in turn the following data blocks of the host machine hard disk: 20000-40000, 78, 80000-90000, 70010-70080. Clearly, in FIG. 2a, the huge file A has an incontiguous physical position distribution on the host machine hard disk and the VM file C has an incontiguous virtual position distribution on the virtual hard disk. At step 13, an actual physical position distribution of the VM file C on the host machine hard disk is calculated according to the obtained virtual position distribution and physical position distribution. The process of obtaining the actually physical position distribution is illustrated in detail.

The VM file C occupies data blocks 3000-3100 on the virtual hard disk, that is, from the 3001^{st} block (counted from the 0^{th} block) in the huge file A which corresponds to the virtual hard disk, the VM file C occupies 101 blocks. Thus, it is necessary to calculate the physical position distribution from the 3001^{st} block of the huge file A on the host machine hard disk occupied by the 101 blocks. As shown in FIGS. 2a-2b, the position distribution of the huge file A in the host machine hard disk begins with a data block 20000. Accordingly, an actual physical position on the host machine hard disk occupied by the 101 blocks of the huge file A from the 3001^{st} block of the huge file A is blocks 23000-23100 on the host machine hard disk. Then, the VM file C occupies a data block 30010 on the virtual hard disk, that is, it is necessary to calculate a physical position on the host machine hard disk occupied by the 30011^{th} block of the huge file A.

According to calculations, first, the huge file A in turn occupies 20001 blocks from block 20000 to 40000, occupies one block at the 78^{th} block and occupies 10001 blocks from block 80000 to 90000, and the sum of these three portions reaches 30003 blocks. Thus, the 30011^{th} block (block 30010) in the huge file A will be located within the section of data blocks 70010-70080 which is occupied by the huge file, i.e., a data block 70016. Therefore, it can be obtained through the above position calculation that the data block 30010 of the VM file C on the virtual hard disk corresponds to the data block 70016 on the host machine hard disk.

Similar to the above calculation, the position on the host machine hard disk occupied by data blocks 19000-21000 of the VM file C on the virtual hard disk continues to be calculated. First, a data block 19000 on the virtual hard disk corresponds to a data block 39000 of the huge file A on the host machine hard disk. The data blocks 19000-21000 of the VM file C totally have a hard disk space of 2001 blocks Thus, it is necessary to calculate the position distribution from the data block 39000 of the huge file A on the host machine hard disk, of totally 2001 blocks of the huge file A, such position distribution on the host machine hard disk will correspond to the data blocks 19000-21000 of the VM file C. The huge file A can provide in turn a 1001-block space from the data block 39000 to 40000, then next provide a one-block space at the block 78 and thereafter, provide 1999 blocks at blocks 80000-81998, leading to a total number of which is just 2001 blocks. Thereby, it is possible to obtain that the physical position distribution on the host machine hard disk occupied by the data blocks 19000-21000 of the VM file C is data blocks 390000-40000, 78 and 80000-81998 on the host machine. As described above, the physical position distribution on the host machine hard disk for the VM file C is obtained according to file allocation information of the VM system and file allocation information of the host machine system. In the following, the defragment is performed according to the physical position distribution.

Typically, a defragment at step 20 can be implemented by using various well-known techniques or software, such as a hard disk defragment program under the operating system Windows 2000® of Microsoft Corporation. A person skilled in the art can understand that since a specific position distribution in the host machine hard disk for each file in the VM system is known, the defragment can be implemented according to a hard disk defragment method in the prior art. The hard disk defragment in the prior art includes modifying, after defragment, file allocation information of the hard disk according to a result of the defragment.

As described above, although the VM file has a virtual position distribution on the virtual hard disk, the VM file is actually still stored on the host machine physical hard disk. Consequently, when the physical position distribution on the physical hard disk for data blocks of the VM file is obtained according to the above method, the VM file and the host machine file can be stored contiguously or substantially contiguously by way of once defragment according to the hard disk defragment method in the prior art, as shown in FIG. 2b, thereby reducing as far as possible the jumping times for the magnetic head when accessing files. Thus, embodiments of the present invention recognize that capability of simultaneously performing defragment of both the host machine hard disk and the VM hard disk during one defragment and simultaneously reduce the number of file fragments on both the host machine hard disk and the VM hard disk, thereby avoiding performing defragment twice.

After completing the above defragment at step 30, the file allocation information of the VM is updated according to the result of the defragment. For example, the new position distribution of the VM file C on the virtual hard disk after the defragment is calculated according to the result of the defragment, and the file allocation information of the VM is updated based on the new position distribution. In an example as shown in FIG. 2b, provided that after the defragment the huge file A corresponding to the virtual hard disk is moved to data blocks 10000-470073 in the host machine hard disk and the VM file C is moved to data blocks 30000-32102 in the host machine hard disk, the above position distribution is recorded and the new position distribution of the VM file C on the virtual hard disk after the defragment is calculated. According to the above position distribution, the VM file C is located at the 20001^{st} block to 22103^{rd} block of the huge file A, whereby on the virtual hard disk the VM file C should be located at data blocks 20000-22102 of the virtual hard disk, counted from the 0^{th} block. The file allocation information of the virtual hard disk is updated by using the above new virtual position distribution of the VM file C.

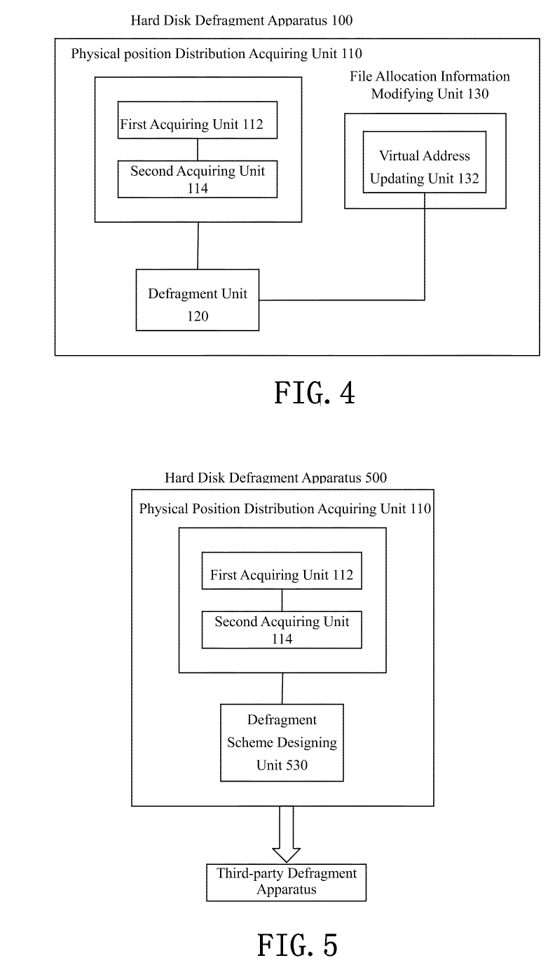

FIG. 4 typically shows a block diagram of a hard disk defragment apparatus 100 according to an embodiment of the present invention. The hard disk defragment apparatus 100 can for example include a physical position distribution acquiring unit 110 having a first acquiring unit 112 and a second acquiring unit 114; a defragment unit 120; and a file allocation information modifying unit 130 having a virtual address updating unit 132. The respective parts are described in detail with reference to the drawings.

The first acquiring unit 112 in the physical position distribution acquiring unit 110 acquires the virtual position distribution of a VM file C in the virtual hard disk according to VM file allocation information. The second acquiring unit 114 of the physical position distribution acquiring unit 110 acquires the physical position distribution in the physical hard disk of data blocks of the VM file according to above virtual position distribution and the host machine file allocation information. When the physical position distribution of the data blocks of the VM file is obtained, the physical position distribution acquiring unit 110 delivers it to the defragment unit 120.

The defragment unit 120 performs defragment according to the above physical position distribution. A person skilled in the art can understand that since the defragment unit 120 has known the position distribution in a host machine hard disk of each file in a VM system, the defragment can be implemented according to the hard disk defragment method in the prior art.

After the above defragment, the file allocation information modifying unit 130 modifies the VM file allocation information according to the result of defragment. For example, the virtual address updating unit 132 calculates the new position distribution of the VM file C on the virtual hard disk after the defragment according to the result of defragment, and the file allocation information modifying unit 130 modifies the VM file allocation information based on the new position distribution.

In an alternative embodiment defragment is performed on both the virtual hard disk and the host machine physical hard disk without activating the VM. According to the alternative embodiment, the physical position distribution acquiring unit 110 needs to acquire the file allocation information of the virtual hard disk without running the virtual machine. A person skilled in the art can understand that the VM defines the format of a huge file corresponding thereto, for example, header information of the VM system and the file allocation information of the virtual hard disk stored at a predetermined position of the huge file. Accordingly, when the type of the VM is determined based on the suffix name of the huge file of the VM (for example, VMWare® can have a suffix name.vmdk), according to the type of the VM, the predetermined position in the huge file where the file allocation information of the virtual hard disk is stored can be ascertained. Then the position distribution in the physical hard disk of the file allocation information of the virtual hard disk can be acquired with reference to the physical position distribution of the huge file in the host machine physical hard disk. Thereby, it is possible to obtain the file allocation information of the host machine hard disk and the file allocation information of the virtual hard disk in the case where the VM does not run, and the defragment is performed based on the file allocation information.

In another alternative embodiment, contiguous storage space for the virtual hard disk is pre-allocated at the time of defragment according to the current size of the virtual hard disk. For example, when the virtual hard disk has been allocated a 40 G hard disk space, a contiguous storage space of 40 G for the virtual hard disk can be pre-allocated during or before the defragment, thereby ensuring the huge file A to be contiguous on the physical hard disk.

In a further alternative embodiment, defragment of the huge file A is given a higher priority. More specifically, it is preferably assured that the huge file A has a contiguous physical position distribution on the host machine hard disk and each VM file has a contiguous virtual position distribution on the virtual hard disk. Alternatively, it is possible to only perform defragment of the huge file A and the virtual file on the virtual hard disk.

In another alternative embodiment, the VM file allocation information is stored in a VM file allocation table (FAT), and the host machine file allocation information is stored in a host machine file allocation table (FAT). The file allocation tables can be read to obtain the file allocation information.

In an additional alternative embodiment, when performing the hard disk defragment, the VM FAT is treated as a VM file during defragment.

It should be appreciated that the term “defragment” here should be understood in a broad sense, and it can refer to both performing defragment of a whole hard disk and performing defragment of a particular portion of the hard disk (such as a hard disk partition). According to the prior art, the defragment can include various algorithms.

It should be appreciated that the present invention can be applied to various cases. For example, when a VM file has a contiguously virtual position distribution in a virtual hard disk defragment can be performed on the host machine hard disk. On the contrary, when each file on the host machine hard disk has a contiguously physical position distribution, it is also possible to perform defragment on the virtual hard disk The present invention can also be applied to a plurality of file system formats, such as but not limited to NTFS, FAT 32, EXT, and so on. The present invention can further include a method and apparatus only for providing a defragment scheme for hard disk defragment. For example, a hard disk defragment apparatus 500 in FIG. 5 can include a defragment scheme designing unit 530 in place of the defragment unit 120 and the file allocation information modifying unit 130. A third-party defragment apparatus can be provided with a defragment scheme as to how to perform defragment according to the obtained physical position distribution in the physical hard disk of data blocks in the VM file (that is, an algorithm as to how to move each data block is designed according to the physical position distribution and is then provided to the third-party defragment apparatus) It is also possible to only provide the obtained physical position distribution to the third-party defragment apparatus.

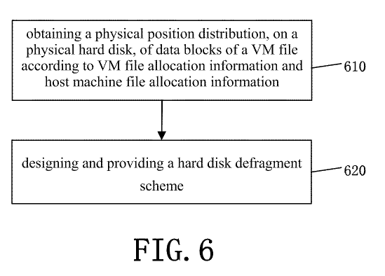

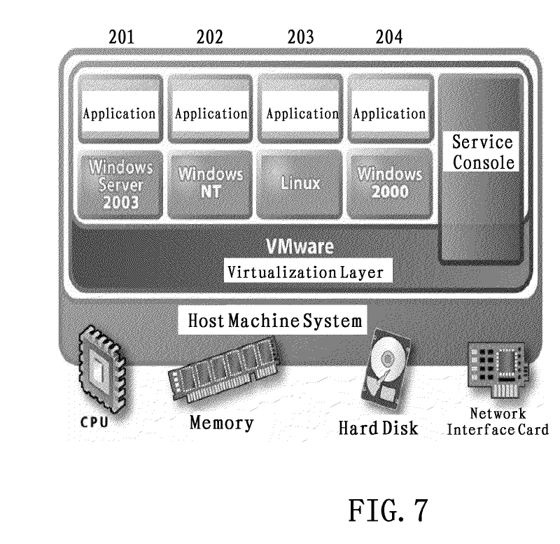

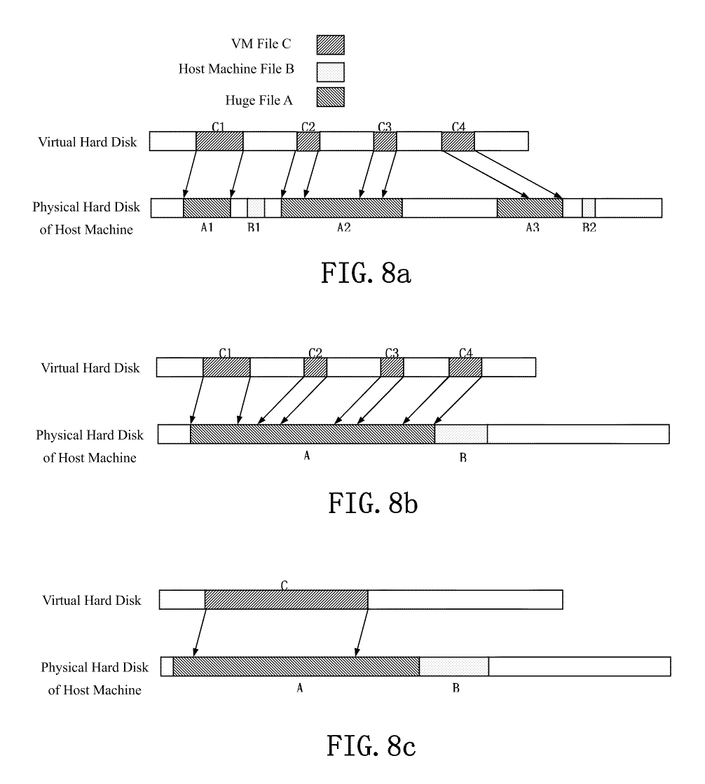

In the former, the third-party defragment apparatus only needs to move each data block according to the provided scheme so as to perform hard disk defragment. In the latter, the third-party defragment apparatus will shoulder the work of calculating how to move data blocks and ultimately completing the hard disk defragment according to the obtained physical distribution based on actual conditions, that is, the hard disk defragment apparatus 500 cannot include the defragment scheme designing unit 530. FIG. 6 shows a flowchart of the above method. Optionally, the hard disk defragment apparatus as shown in FIG. 4 can also include the defragment scheme designing unit 530 so as to provide defragment scheme for the defragment unit 120.

The hard disk defragment apparatus can reside in a host machine system. However, a person skilled in the art can understand that the hard disk defragment apparatus can also reside in part, in a VM. For example, the physical position distribution acquiring unit 110 and the file allocation information modifying unit 130 as shown in FIG. 4 can be located in part or wholly in a VM system; the physical position distribution acquiring unit 110 as shown in FIG. 5 can be located in part or wholly in the VM system. Further, when the second acquiring unit 114 of the physical position distribution acquiring unit 110 resides in the VM system, the second acquiring unit 114 communicates with the host machine system so as to obtain file allocation information of the hard disk of the host machine system.

A person skilled in the art can understand that the apparatuses described here can be implemented in the form of software, hardware or any combination thereof. The present application does not intend to limit the specific apparatus types, so long as they can achieve the object of the present application.

As described above, the host machine system having a VM, achieves contiguous storage of each file on the VM and the host machine with only one defragment, thereby saving the addressing time and times for a hard disk magnetic head, so that the performance of the whole system is improved and the service life of the hard disk is prolonged.

It should be appreciated that the above embodiments, advantages and effects are illustrative rather than limiting. The above embodiments can combine with each other in an appropriate manner to form various implementation modes, and although these possible combinations are not illustrated in detail in the specification, they should be considered to have been specifically disclosed in the specification.

The present invention is illustrated with reference to the specific embodiments. However, a person skilled in the art can understand that various changes can be made and each component can be substituted for an equivalent thereof without departing from the spirit and scope of the present invention as defined by the accompanying claims. Moreover, a person skilled in the art can realize that various components and operations of the present invention that are specifically described here are not exclusive but only provided for facilitating understanding and evaluating the inventive principles and advantages of the present invention, instead of for limiting the present invention in any manner. Thus, the specification and the drawings should be deemed to be illustrative rather than limiting, and the above changes and substitution should be deemed to be within the scope of the present invention.

We claim:

1. A method for performing defragment on a physical hard disk of a host machine system having a virtual machine (VM) system, the method comprising:
obtaining a physical position distribution on the physical hard disk of data blocks constituting a VM file in the VM system according to VM file allocation information of the VM system and host machine file allocation information of the host machine system.

2. The method according to claim 1, further comprising:
performing defragment on the physical hard disk of the host machine system according to the physical position distribution of the data blocks; and
modifying the VM file allocation information according to the result of the defragment.

3. The method according to claim 1, further comprising:
designing a hard disk defragment scheme for the physical hard disk according to the physical position distribution of the data blocks.

4. The method according to claim 2, wherein modifying the VM file allocation information according to the result of the defragment further comprises:
obtaining a new virtual position distribution of the data blocks of a virtual hard disk of the VM system according to a position distribution on the physical hard disk after the defragment and obtaining a new physical position of data blocks of the VM file; and
modifying the VM file allocation information according to the new virtual position distribution.

5. The method according to claim 2, wherein the defragment of the VM file has higher priority during performing defragment on the physical hard disk of the host machine system of the virtual hard disk of the VM system.

6. The method according to claim 2, wherein performing defragment on the physical hard disk of the host machine system according to physical position distribution of the data blocks further comprises:
pre-allocating for a virtual hard disk of the VM system a predetermined space on the physical hard disk of the host machine before performing the defragment.

7. The method according to claim 1, further comprising:
reading a file allocation table of the VM system to obtain the VM file allocation information; and
reading a file allocation table of the host machine system to obtain the host machine file allocation information.

8. The method according to claim 7, further comprising treating the file allocation table of the VM system the same as a VM file during the defragment.

9. The method according to claim 1, wherein the VM file allocation information is obtained from a predetermined position on a virtual hard disk of the VM system based on the type of VM system.

10. The method according to claim 1, wherein obtaining a physical position distribution on the physical hard disk of data blocks constituting a VM file in VM system according to VM file allocation information of the VM system and host machine file allocation information of the host machine system further comprises:
obtaining a virtual position distribution on a virtual hard disk of the VM system of the data blocks of the VM file according to the VM file allocation information; and
obtaining the physical position distribution on the physical hard disk of the data blocks of the VM file according to the virtual position distribution and the host machine file allocation information.

11. A hard disk defragment apparatus for performing defragment on a physical hard disk of a host machine system having a virtual machine (VM) system, the hard disk defragment apparatus comprising:
a physical position distribution acquiring unit for obtaining a physical position distribution on the physical hard disk of data blocks constituting a VM file in the VM system according to VM file allocation information of the VM system and host machine file allocation information of the host machine system.

12. The hard disk defragment apparatus according to claim 11, further comprising:
a defragment unit for performing defragment on the physical hard disk of the host machine system according to the physical position distribution of the data blocks; and
a file allocation information modifying unit for modifying the VM file allocation information according to the result of the defragment.

13. The hard disk defragment apparatus according to claim 11, further comprising:
a defragment scheme designing unit for designing a defragment scheme for the physical hard disk according to the physical position distribution of the data blocks.

14. The hard disk defragment apparatus according to claim 12, further comprising:
a virtual address updating unit for obtaining a new virtual position distribution of the data blocks of a virtual hard disk of the VM system according to a position distribution on the physical hard disk after the defragment and a new physical position of the data blocks of the VM file,
wherein the file allocation information modifying unit modifies the VM file allocation information according to the new virtual position distribution.

15. The hard disk defragment apparatus according to claim 12, wherein the defragment unit gives higher priority to the defragment on the VM file during performing the defragment.

16. The hard disk defragment apparatus according to claim 12, wherein the defragment unit pre-allocates for a virtual hard disk of the VM system a predetermined space on the physical hard disk of the host machine before performing the defragment.

17. The hard disk defragment apparatus according to claim 11, wherein the physical position distribution acquiring unit reads a file allocation table of the VM system to obtain the VM file allocation information, and reads a file allocation table of the host machine system to obtain the host machine file allocation information.

18. The hard disk defragment apparatus according to claim 17, wherein the defragment unit treats the file allocation table of the VM system the same as a VM file during the defragment.

19. The hard disk defragment apparatus according to claim 11, wherein the physical position distribution acquiring unit obtains the VM file allocation information from a predetermined position on a virtual hard disk of the VM system based on the type of VM system.

20. The hard disk defragment apparatus according to claim 11, wherein the physical position distribution acquiring unit further comprises:
a first acquiring unit for obtaining a virtual position distribution on a virtual hard disk of the VM system of the data blocks of the VM file according to the VM file allocation information; and
a second acquiring unit for obtaining the physical position distribution on the physical hard disk of the data blocks of the VM file according to the virtual position distribution and the host machine file allocation information.

21. An article of manufacture tangibly embodying a computer readable program containing a computer executable program instructions which, when executed by the computer, implements the steps of a method according to claim 1.
